(19) United States
(12) Patent Application Publication
(10) Pub. No.: US 2009/0108191 A1
(43) Pub. Date: Apr. 30, 2009

(54) Mass Spectrometer gain adjustment using ion ratios

(76) Inventors: George Yefchak, Santa Clara, CA (US); Kenneth L. Staton, San Carlos, CA (US); Gangqiang Li, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/927,995

(22) Filed: Oct. 30, 2007

(51) Int. Cl. G12B 13/00; H01J 49/00

(52) U.S. Cl. 250/252.1; 250/281

(57) ABSTRACT

The gain of the ion detector of a mass spectrometer is calibrated by using the ion detector to measure a ratio of the abundances of at least two ion species having a known abundance ratio. The gain of the ion detector is changed until the measured abundance ratio matches the known abundance ratio.

### BACKGROUND

In mass spectrometry, a mass analyzer separates ions generated from a sample of interest in accordance with their mass-to-charge ratio (m/z) and an ion detector measures an ion abundance for the separated ions. To obtain accurate quantitative information, the gain of the ion detector must be properly calibrated. The ion detector has a defined dynamic range. Consequently, the gain of the ion detector must be set high enough to enable single-ion events to be detected efficiently, but low enough so that a high abundance of ions will not saturate the ion detector.

In mass spectrometry, the ion detector typically performs ion abundance measurements as follows. Ions from the mass analyzer strike a detector dynode surface, causing the dynode surface to emit electrons. An applied electric field accelerates these so-called “secondary electrons” towards a second dynode, where the secondary electrons cause the second dynode to emit more electrons. This process continues through many dynode stages in a device called an electron multiplier. Since, on average, each electron striking a dynode causes the dynode to emit more than one electron, there is a net multiplication of electrons at each dynode stage. The electron multiplier gain is typically in the range of 10⁶-10⁹. This provides sufficient gain so that the final dynode outputs an electric current large enough to be measurable.

Although an electron multiplier is capable of providing a very high gain, the electron multiplication process has at least one disadvantage, namely, that nominally identical sets of ions received from the mass analyzer do not always result in the same output current. Instead, such identical sets of ions result in a distribution of output current pulse heights known as a pulse height distribution and abbreviated as PHD. FIG. 1A is a graph showing an example of a simulated PHD for a typical electron multiplier normalized to unit mean. To accurately relate the measured output current with an actual number of incoming ions, the gain of the ion detector must be calibrated to determine the average output current generated in response to one ion. This is equivalent to finding the mean of the PHD.

Calibration of the ion detector cannot simply be done once in the factory and last the life of the mass spectrometer. During operation of the mass spectrometer the initial target of the ion detector ages, which causes the average output current for one ion to changes with time. Thus, the calibration process must be one that can be carried out routinely in the field, during normal operation of the mass spectrometer.

Accurate generation and analysis of PHDs can be difficult to perform for a number of reasons. A reliable source of single-ion events is required. However, this is not the most challenging issue. Measurements of the low-intensity signals which determine the left-hand side of the PHD are inherently difficult since low-intensity signals are difficult to distinguish from noise. Accurate measurements are required to obtain a reliable estimate of the mean since a significant portion of the area under the curve is determined by the low-intensity signals.

Typically, the output current of the electron multiplier is fed to an analog-to-digital converter (ADC) that converts the current to a digital value that represents the magnitude of the current. The conversion process subjects the output current to quantization. FIG. 1B is a graph showing an example of a simulated PHD as represented by a relatively small number of ADC bins. Typically, the ADC has an input range designed to accommodate a wide dynamic range of input signals, including those from multiple-ion events. Thus, the signal intensities tend due to single-ion events tend to fall across only a small number of the lowest-intensity bins. This results in a highly degraded representation of the PHD curve shape illustrated in FIG. 1A. For these reasons, estimates of the PHD mean can have significant error, perhaps as high as 50% or more.

One method for adjusting the gain of the ion detector follows easily from theory but is difficult to implement in practice. In this, the pulse-height distribution for single-ion events is measured, and the threshold of the detector is then adjusted until the detector counts a certain percentage t of single-ion events. An optimum value for the threshold level t was calculated to be 0.35 under certain conditions, according to Kevin L. Hunter and Richard W. Stresau in Calibration of Ion Abundance in a TOF-MS Spectrum, PROC. 46TH ASMS CONFERENCE ON MASS SPECTROMETRY AND ALLIED TOPICS, 911 (1998). This calibration method would provide a from-first-principles absolute calibration and would reduce the need for calibration using prepared calibration samples. Although an absolute calibration method can compensate for detector aging, voltage drift, etc., it would not eliminate the need for such calibration samples, because different analytes can have different response factors due to varying ionization efficiencies, etc. Moreover, such absolute calibration method is not easy to carry out because, as will be discussed in more detail below, pulse-height distributions are difficult to measure accurately.

Accordingly, what is needed is a simple, reliable and accurate way to calibrate the ion detector of a mass spectrometer.

### BRIEF DESCRIPTION OF THE DRAWINGS

FIG. 1A is a graph showing an example of a simulated PHD for a typical electron multiplier normalized to unit mean.

FIG. 1B is a graph showing an example of a simulated PHD as represented by a relatively small number of ADC bins.

FIG. 2 is a flow chart showing an example of a method in accordance with an embodiment of the invention for calibrating the gain of the ion detector of a mass spectrometer.

FIGS. 3A, 3B and 3C are graphs schematically illustrating the effect of three exemplary gain settings on the digital output of an ADC that digitizes the output signal generated by the ion detector.

FIGS. 4A, 4B and 4C are graphs schematically showing the variation of detection efficiency with incident ion flux (logarithmic scale) for the above-described exemplary ion detector at the gain settings illustrated in FIGS. 3A, 3B and 3C, respectively.

FIGS. 5A, 5B and 5C are bar charts showing the ion detector output signal at the m/z ratios of two exemplary ion species in a sample comprising species having a known abundance ratio for the above-described exemplary ion detector at the gain settings illustrated in FIGS. 3A, 3B and 3C, respectively.

FIG. 6 is a flow chart showing an example of a method in accordance with another embodiment of the invention for calibrating the gain of the ion detector of a mass spectrometer.

FIG. 7 is a block diagram showing an example of the gain-changing block shown in FIG. 6.

FIG. 8 is a block diagram of an example of a mass spectrometer in accordance with an embodiment of the invention.

FIG. 9 is a block diagram showing an example of a manual embodiment of the gain adjustment system shown in FIG. 8 for use with an ion detector that has manual gain adjustment.

FIG. 10 is a block diagram showing an example of an automatic embodiment of the gain adjustment system shown in FIG. 8 that automatically adjusts the gain of the ion detector.

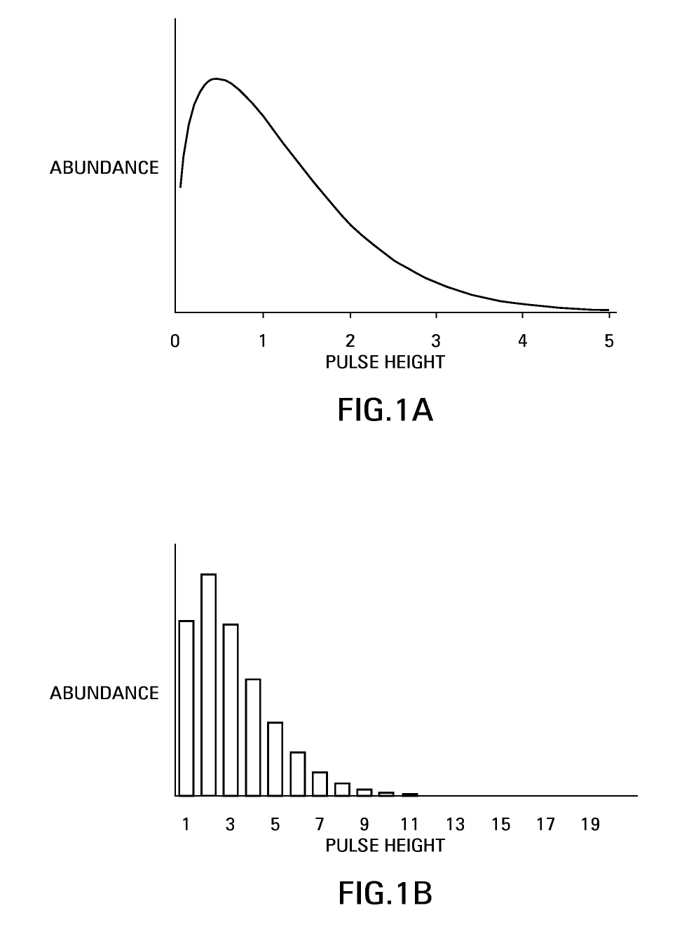

### DETAILED DESCRIPTION

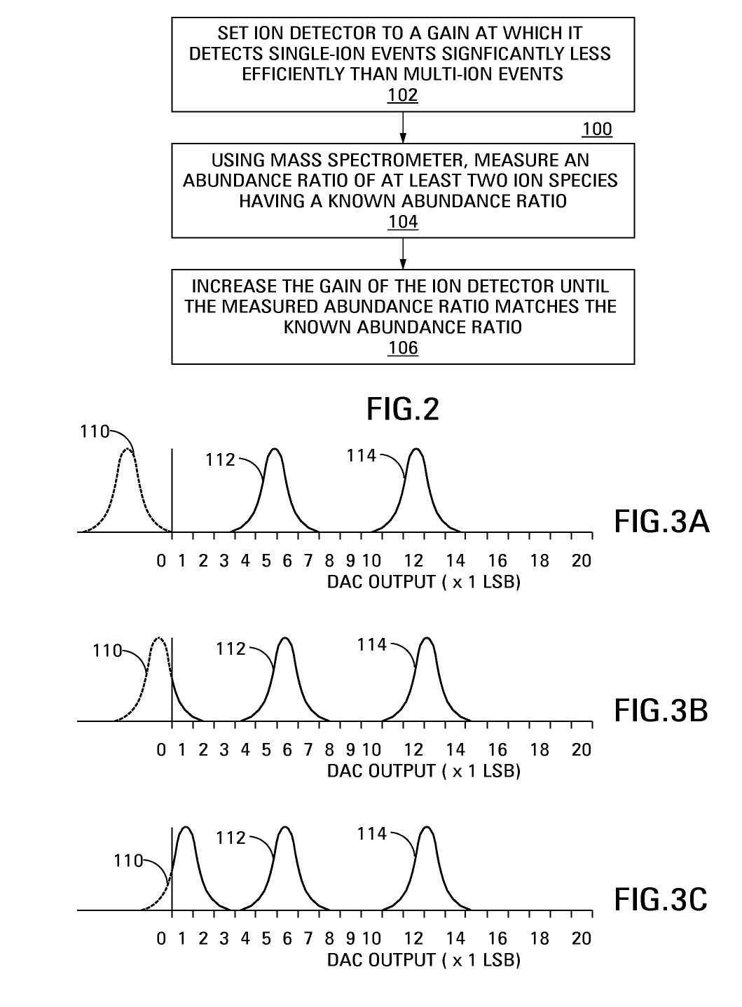

FIG. 2 is a flow chart showing an example of a method 100 in accordance with an embodiment of the invention for calibrating the gain of the ion detector of a mass spectrometer. In block 102, the gain of the ion detector is set to a gain at which the ion detector detects single-ion events significantly less efficiently than multi-ion events. In block 104, the mass spectrometer, including its ion detector, is used to measure an abundance ratio of at least two ion species having a known abundance ratio. In block 106, the gain of the ion detector is increased until the measured abundance ratio matches the known abundance ratio.

As used in this disclosure, the abundance ratio of two ion species of interest is the abundance of the more-abundant ion species divided by the abundance of the less-abundant ion species. The abundance ratio is always greater than unity unless the ion species are equal in abundance.

Many convenient sources of samples composed of two or more species having a known abundance ratio exist. For example, air leaks into most electron impact mass spectrometers to provide oxygen ions and nitrogen ions in a known abundance ratio. In electrospray mass spectrometers, molecular constituents of the solvent in which the sample is dissolved provide ions having a known abundance ratio. For example, a molecular constituent having one or more carbon-12 atoms has a mass-to-charge ratio that differs by one from the same molecular constituent in which one of the carbon atoms is a carbon-13 atom. The abundance ratio between the two molecular constituent species is about 91/n, where n is the number of carbon atoms in the molecular constituent. Acetonitrile (CH₃CN), a common solvent used in electrospray mass spectrometry, produces ion species with mass-to-charge ratios of 41 and 42. Since acetonitrile has two carbon atoms, the known abundance ratio of acetonitrile is about 45.5.

Rather than setting the ion detector gain by measuring the average signal generated by the ion detector in response to single-ion events, method 100 sets the ion detector gain by measuring the abundance ratio for two or more ions having a known abundance ratio. Method 100 does not provide a from-first-principles absolute calibration, but enables the ion detector gain to be quickly adjusted with adequate precision and repeatability.

FIGS. 3A, 3B and 3C are graphs schematically illustrating the effect of three exemplary gain settings on the digital values output by an ADC that digitizes the output signal generated by the ion detector. The range of the gain settings is typical for a variable-gain ion detector. At each gain setting, the digital output of the ADC is shown for single-ion events 110, double-ion events 112 and multi-ion events 114. Multi-ion events are events of more than two ions. In each graph, the abundance of ion events that cause the ion detector to generate an output signal of a given level is plotted along the y-axis and the digital value to which the ADC converts a signal of that level is plotted along the x-axis in terms of multiples of the least-significant bit of the ADC.

In FIG. 3A, the gain of the ion detector is set sufficiently low that no single-ion events cause the ion detector to generate an output signal level that the ADC converts to a digital value of one or more LSB. Thus, although the ion detector may detect many single-ions events, the gain of the detector is so low that none of these single-ion events cause the output signal level to exceed the threshold level of the ADC, i.e., a level that causes the ADC to output a digital value of 1 LSB or more. Consequently, at this gain setting, single-ion events effectively go undetected. In contrast, double-ion events 112 and multi-ion events 114 cause the detector to generate output signal levels that the ADC converts to digital values of one or more LSB at this gain setting.

In FIG. 3B, the gain of the ion detector is set such that about 25% of the single-ion events 110 cause the ion detector to generate output signal levels that the ADC converts to digital values of one or more LSB. The remaining 75% of the single-ion events cause the ion detector to generate output signal levels below the threshold level of the ADC. Such single-ion events effectively go undetected. The 25% of the single-ion events that result in he ADC generating a digital value of one LSB or more are those single-ion events whose intensities fall within the top 25th percentile of the intensity distribution of the single-ion events. At this gain setting, double-ion events 112 and multi-ion events 114 result in the ADC generating digital values in excess of one LSB.

In FIG. 3C, the gain of the ion detector is set such that 75% of the single-ion events 110 cause the detector to generate output signal levels that the ADC converts to digital values of one or more LSB. The remaining 25% of the single-ion events cause the ion detector to generate output signal levels below the threshold level of the ADC. Such single-ion events effectively go undetected. At this gain setting, double-ion events 112 and multi-ion events 114 result in the ADC generating digital values in excess of one LSB.

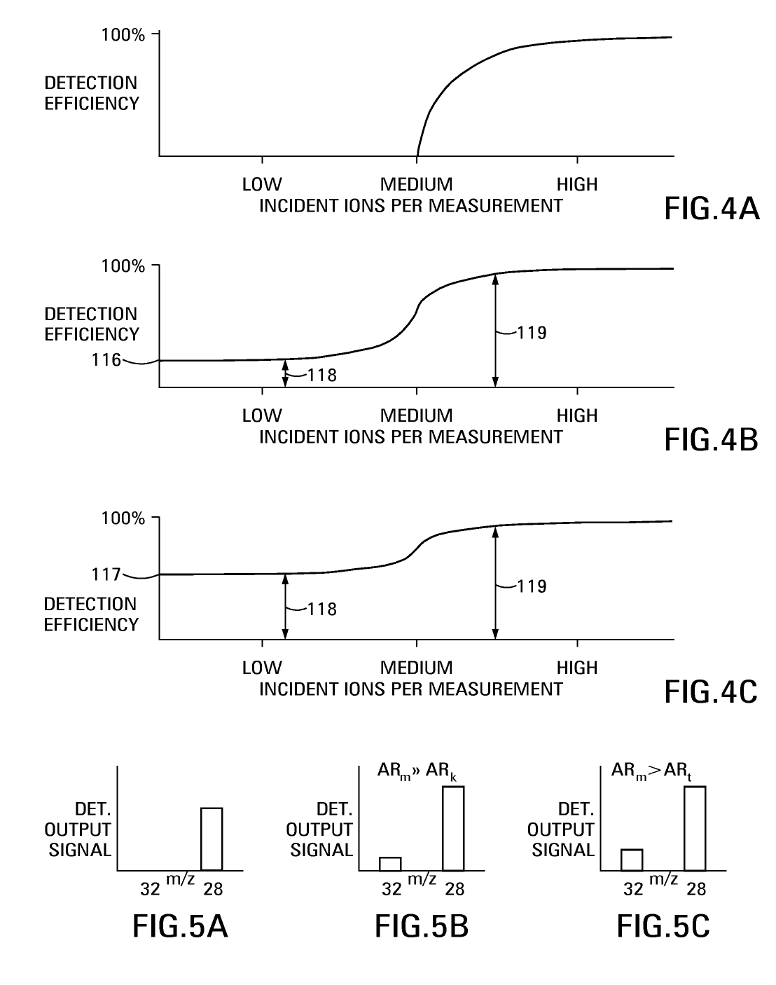

FIGS. 4A, 4B and 4C are graphs schematically showing the variation of detection efficiency with the number of incident ions per detection event for the above-described exemplary ion detector at the gain settings illustrated in FIGS. 3A, 3B and 3C, respectively. The number of incident ions per event is plotted on a logarithmic scale. A low number of incident ions per event corresponds to a single ion event. A high number of incident ions per event corresponds to a multi-ion event. The graphs shown in FIGS. 4A, 4B and 4C are based on work disclosed by Kevin L. Hunter and Richard W. Stresau in Calibration of Ion Abundance in a TOF-MS Spectrum, PROC. 46TH ASMS CONFERENCE ON MASS SPECTROMETRY AND ALLIED TOPICS, 911 (1998).

FIGS. 4A, 4B and 4C collectively show that the gain setting of the ion detector has relatively little effect on the detection efficiency when the number of ions per event is high, but has a significant effect when the number of ions per event is low.

FIG. 4A shows that, at the low-gain setting of the ion detector, the detection efficiency is zero when the number of ions per event is low. At the medium- and high-gain settings shown in FIGS. 4B and 4C, respectively, the detection efficiency is significantly greater than zero when the number of ions per event is low. However, increasing the gain has had little effect on the detection efficiency when the number of ions per event is high. Reference numerals 116 and 117 in FIGS. 4B and 4C, respectively, show the detection efficiency of the ion detector for single-ion events at the gain settings illustrated in FIGS. 3B and 3C.

FIGS. 4B and 4C additionally illustrate the detection efficiency of the ion detector with respect to two ion species having differing abundances. The more-abundant ion species produces substantially more multi-ion events than single-ion events, whereas the less-abundant ion species produces substantially more single-ion events than multi-ion events. The detection efficiency with respect to the less-abundant ion species is indicated at 118 and that with respect to the more-abundant ion species is indicated at 119. At the lower-gain setting illustrated in FIG. 4B, the detection efficiency 118 with respect to the less-abundant ion species is significantly less than the detection efficiency 119 with respect to the higher-abundance species because of the significantly smaller number of multi-ion events attributable to the less-abundant species. At the higher-gain setting illustrated in FIG. 4C, the efficiency 118 with which the detector detects less-abundant ion species is substantially increased compared with that at the lower gain setting illustrated in FIG. 4B. At the higher gain setting, the ratio of the measured abundances will be closer to the known abundance ratio.

FIGS. 5A, 5B and 5C are bar charts showing respective levels of the ion detector output signal at the m/z ratios of two exemplary ion species in a sample comprising species having a known abundance ratio for the above-described exemplary ion detector at the gain settings illustrated in FIGS. 3A, 3B and 3C, respectively. In the example shown, the sample is air, and the species are nitrogen and oxygen. In air, nitrogen and oxygen have a mass-to-charge ratio (m/z) of 28 and 32, respectively, and an abundance ratio of 3.72. As noted above, this disclosure, abundance ratios are expressed in terms of a ratio of the more-abundant ion species to the less-abundant ion species.

Samples that provide other ion species can alternatively be used, provided that the abundance ratio of the ion species is known. For example, the oxygen and argon species in air, which have an abundance ratio of about 22.5, or the nitrogen and argon species in air, which have an abundance ratio of about 84, could be used. The ion species used must differ in abundance such that the number of ions of the less-abundant species per measurement is in the low range indicated in FIGS. 4A-4C and the number of ions of the more-abundant species per measurement is in the medium-to-high range indicated in FIGS. 4A-4C. Additionally, the ion species should differ in abundance sufficiently that the signal level distributions shown in FIGS. 3A-3C do not overlap. Oxygen and nitrogen in air meet these criteria.

At the low gain setting of the ion detector shown in FIG. 5A, the ion detector effectively detects only multi-ion events, as described above. Only the more-abundant species with m/z=28 generates enough multiple-ion events for the ion detector to detect them. Consequently, the ion detector generates its output signal in response to the more-abundant species alone. In the example shown, the ion detector generates no output signal in response to the less-abundant species with m/z=32. Consequently, the measured abundance ratio is infinite.

As the gain of the ion detector is increased relative to the low-gain setting shown in FIGS. 3A, 4A and 5A, the ion detector is able to detect some of the ions of the less-abundant species with m/z=32, as shown in FIG. 5B. However, because the ions of the less-abundant species produce more single-ion events in the ion detector than the ions of the more-abundant species, the ion detector detects the ions of the less-abundant species significantly less efficiently than it detects the ions of the more-abundant species. Consequently, the measured abundance ratio ARₘ shown in FIG. 5B remains significantly greater than the known abundance ratio ARₖ.

As the gain of the ion detector is increased relative to the medium-gain setting shown in FIGS. 3B, 4B and 5B, the detection efficiency of the ion detector with respect to single-ion events approaches that with respect to multi-ion events, as shown in FIG. 5C. Consequently, the detection efficiency of the ion detector with respect to the ions of the less-abundant species approaches that with respect to the ions of the more-abundant species, and the measured abundance ratio ARₘ approaches the known abundance ratio ARₖ, although the measured abundance ratio remains greater than the known abundance ratio.

In practice, the detection efficiency of the ion detector with respect to the less-abundant ion species approaches the detection efficiency with respect to the more-abundant ion species asymptotically. Consequently, the measured abundance ratio approaches the known abundance ratio asymptotically. The ion detector would have to have a very high gain for the measured abundance ratio to equal the known abundance ratio. Such very high gain would incur the risk of ion detector overload at high ion fluxes.

To obtain a gain setting that optimizes the dynamic range of the ion detector, a target abundance ratio that is greater than the known abundance ratio by a defined fraction of the known abundance ratio is chosen, and the ion detector gain is increased until the measured abundance ratio falls to a value equal to the target abundance ratio. A measured abundance ratio equal to the target abundance ratio will be regarded as a measured abundance ratio that matches the known abundance ratio.

A target abundance ratio that is greater than the known abundance ratio by about 10% of the known abundance ratio, i.e., a target abundance ratio of about 110% of the known abundance ratio, will typically result in a gain setting that is suitable for use in many applications. A target abundance ratio greater than or less than 110% of the known abundance ratio may alternatively be used. In some circumstances, a substantially more complex and time-consuming “from first principles” method can be used to set the gain of the ion detector. Then, the ion detector with its gain set as just described is used to measure the abundance ratio of the two species, e.g., nitrogen and oxygen in air, that will later be used to practice an embodiment of the above-described gain-setting method in accordance with the invention. The abundance ratio measured as just described is then used as the target abundance ratio each time the above-described method is later used to set the gain of the ion detector. As a further alternative, a target abundance ratio for various pair of ion species may specified by the manufacturer of the mass spectrometer or the ion detector.

A calibration method in accordance with embodiments of the invention exploits the detection efficiency characteristics described above with reference to FIGS. 4A, 4B and 4C to set the gain of the ion detector. In the example of method 100 described above with reference to FIG. 2, in block 102, the ion detector is set to a gain at which the ion detector detects single-ion events significantly less efficiently than multi-ion events. In some embodiments of block 102, the ion detector is set to a gain similar to that exemplified in FIGS. 3A, 4A and 5A, in which the efficiency with which the ion detector detects single-ion events is substantially zero. In other embodiments of block 102, the ion detector is set to a gain at which the detection efficiency with respect to single-ion events is less than one-tenth of that with respect to multi-ion events. In yet other embodiments of block 102, the ion detector is set to a gain at which the detection efficiency with respect to single-ion events is less than one-fifth of that with respect to multi-ion events. In yet other embodiments of block 102, the ion detector is set to a gain at which the detection efficiency with respect to single-ion events is less than one-half of that with respect to multi-ion events. In block 104, the abundance ratio of at least two ion species having a known abundance ratio is measured using the mass spectrometer. In block 106, the gain of the ion detector is increased towards or beyond that illustrated in FIG. 5A until the measured abundance ratio is equal to the target abundance ratio that differs from the known abundance ratio by a defined fraction of the known abundance ratio.

In method 100 described above with reference to FIG. 2, the detector gain is initially set to a low value in block 102 and then, in block 106, the gain of the ion detector is progressively increased until the measured abundance ratio falls to a value equal to the target abundance ratio. This provides an operationally-convenient way of setting the gain of the ion detector since direction in which the gain of the ion detector is to be changed is known. However, there is no need to set the gain of the ion detector to a low value initially.

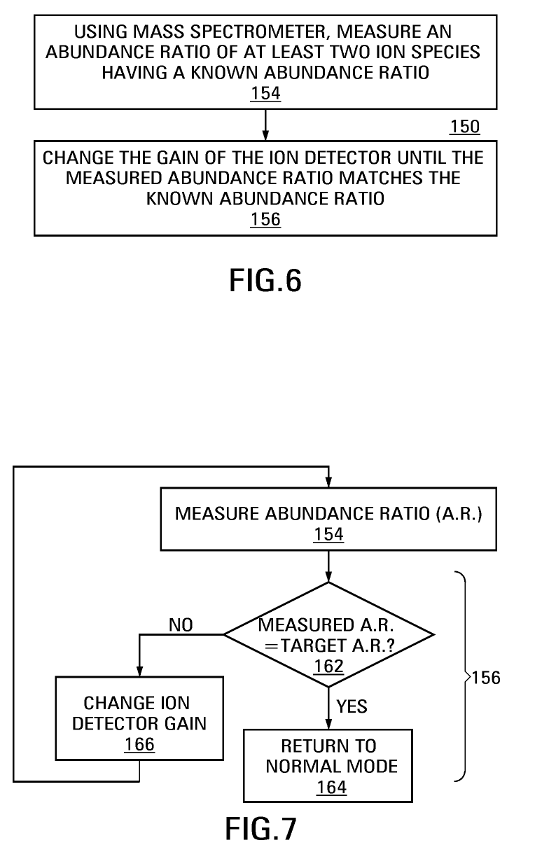

FIG. 6 is a flow chart showing an example of a method 150 in accordance with another embodiment of the invention for calibrating the gain of the ion detector of a mass spectrometer. In block 154, the mass spectrometer, including its ion detector, is used to measure an abundance ratio of at least two ion species having a known abundance ratio. In block 156, the gain of the ion detector is changed until the measured abundance ratio matches the known abundance ratio.

In this embodiment, the ion detector initially has an arbitrary gain. In block 156, the gain of the ion detector is changed until the measured abundance ratio matches the known abundance ratio. When the initial gain of the ion detector is initially greater than the gain at which the measured abundance ratio matches the known abundance ratio, changing the gain of the ion detector involves reducing the gain of the ion detector until the measured abundance ratio increases to a value that matches the known abundance ratio When the initial gain of the ion detector is initially less than the gain at which the measured abundance ratio matches the known abundance ratio, changing the gain of the ion detector involves increasing the gain of the ion detector until the measured abundance ratio falls to a value that matches the known abundance ratio, as in the embodiment described above with reference to FIG. 2. Also, as described above with reference to the method embodiment described above with reference to FIG. 2, in method 150, the measured abundance ratio has an asymptotic relationship to the known abundance ratio as the gain of the ion detector is changed. A measured abundance ratio equal to a target abundance ratio that is greater than the known abundance ratio by a predetermined fraction of the known abundance ratio will be regarded as a measured abundance ratio that matches the known abundance ratio, as described above.

Referring to FIGS. 2 and 6, the gain of the ion detector may be increased in block 106 and the gain of the ion detector may be changed in block 156 manually or automatically. In an example of manual gain increasing or changing, the measured abundance ratio is communicated to a human operator, e.g., by displaying a value for the measured abundance ratio, and the ion detector has a manually-operated gain control, e.g., a gain control knob. In block 106, the operator operates the manually-operated gain control to increase the gain of the ion detector until the measured abundance ratio communicated to the operator falls to a value equal to a target abundance ratio that differs from the known abundance ratio by the predefined difference. In block 156, the operator operates the manually-operated gain control in the appropriate direction to change the gain of the ion detector until the measured abundance ratio communicated to the operator is equal to the target abundance ratio that differs from the target abundance ratio by the predefined difference. In an example of automatic gain increasing or changing, the mass spectrometer is set to an ion detector set-up mode in which the measured abundance ratio is compared with a target abundance ratio that is greater than the known abundance ratio by the predefined difference. In embodiments of method 100 described above with reference to FIG. 2, setting the ion detector to its set-up mode additionally causes block 102 to be performed. In this, the ion detector is set to a gain at which it detects single-ion events significantly less efficiently than multi-ion events. Then, in block 106, a servo increases the gain of the ion detector until the measured abundance ratio is equal to the target abundance ratio. In method 150, in block 156, a servo changes the gain of the ion detector until the measured abundance ratio is equal to the target abundance ratio.

FIG. 7 is a block diagram showing an example of block 156 of FIG. 6 in more detail. In this example, block 156 is composed of block 162, block 164 and block 166. An example of block 106 is FIG. 2 is similar in structure.

Block 154 is performed to measure the abundance ratio of at least two ion species, as described above. Then block 156 is performed. In block 162, a test is performed to determine whether the measured abundance ratio measured in block 156 is equal to the target abundance ratio. Abundance ratio is abbreviated as A.R. in FIG. 7. A YES result in block 162 causes execution to advance to block 164, where the ion detector is returned to its normal operating mode. A NO result in block 162 causes execution to advance to block 166, where the ion detector gain is changed. Execution then returns to block 154, where another measurement of the abundance ratio is made. In embodiments in which block 154 is performed continuously, execution returns to block 162. Optionally, block 166 tracks differences between the measured abundance ratio and the target abundance ratio in successive performances of block 162 to determine the direction (increase or decrease) in which the gain of the ion detector should be changed. This ensures that successively performing block 156 will cause the measured abundance ratio to converge on the target abundance ratio.

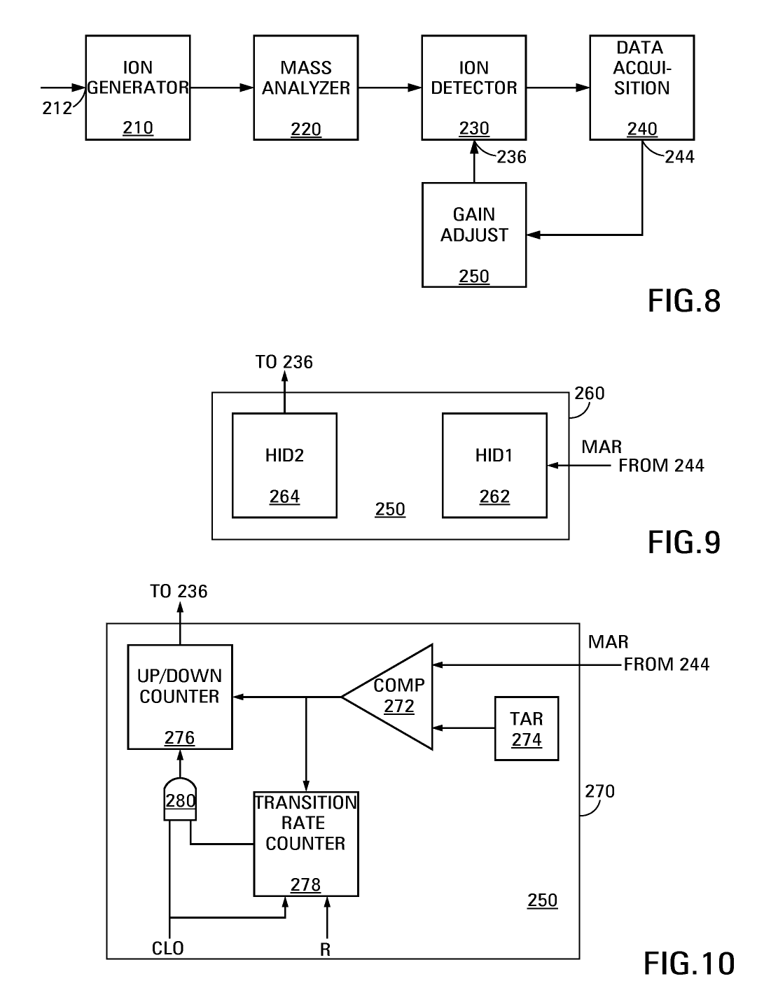

FIG. 8 is a block diagram of an example of a mass spectrometer 200 in accordance with an embodiment of the invention. Mass spectrometer 200 is composed of an ion generator 210, a mass analyzer 220 and an ion detector 230 as is conventional in many types of mass spectrometer. Ion generator 210 has a sample input 212 at which it receives samples for analysis. Ion generator 210 ionizes the sample received at its input and passes the resulting ions to mass analyzer 220. Mass analyzer 220 temporally separates the ions in accordance with the mass-to-charge ratio of the respective species of the ions. Mass analyzer 220 may be a time-of-flight mass analyzer, as known in the art. Other types of mass analyzer that separate ions temporally rather than spatially such that all the ions are detected by a common detector are known in the art and may be used as mass analyzer 220. After temporal separation by mass analyzer 220, the ions derived from the sample pass to ion detector 230, which generates an electrical signal that represents the relative abundance of the ions of each ion species that enters the ion detector, as described above. Ion detector 230 includes an analog-to-digital converter (not separately shown) that converts the electrical signal to a digital signal.

Ion detector 230 has a calibration mode. In the calibration mode of ion detector 230, the gain of the ion detector is adjustable by means of a gain input provided to a gain control input 236. The gain input provided to gain control input 232 may be a manual gain input or an electrical gain input. The gain of the ion detector is adjusted to provide an optimum compromise between signal-to-noise ratio and detector saturation.

Mass spectrometer 200 is additionally composed of a data acquisition system 240 and a gain adjusting system 250. Data acquisition system 240 is electrically connected to receive successive values of the digital signal generated by ion detector 230. During normal operation of mass spectrometer 200, data acquisition system processes 240 the digital signal provided by ion detector 230 to generate data relating to the ion species. In one example, data acquisition system 240 generates data indicating an abundance for each possible value of mass-to-charge ratio, or for those mass-to-charge ratios having a non-zero abundance.

Additionally, when ion detector 230 is in its calibration mode, data acquisition system 240 processes the digital signal output by the ion detector to generate data representing a measured abundance ratio between two or more ion species whose abundance ratio is known. Gain adjusting system 250 performs the function of adjusting the gain of ion detector 230 to make the measured abundance ratio determined by data acquisition system 240 match the known abundance ratio of the two or more specific ion species.

To calibrate the ion detector 240 of mass spectrometer 200, a sample comprising two or more species having a known abundance ratio is input to the sample input 212 of ion generator 210. Optionally, ion detector 230 is initially set to a gain at which it detects single ion events significantly less efficiently than multi-ion events, as described above with reference to FIG. 2. When the ions of the different species reach ion detector 230, the ion detector detects the ions of each species and generates a respective digital signal that is output to data acquisition system 240. Data acquisition system 240 calculates a measured abundance ratio between the species and outputs the result to gain adjusting system 250. Unless the measured abundance ratio determined by data acquisition system 240 is equal to a target abundance ratio that is greater than the known abundance ratio of the two or more specific ion species by a predetermined difference, gain adjusting system 250 adjusts the gain of ion detector 230. In an embodiment, gain adjusting system 250 increases or decreases the gain of ion detector 230, as appropriate, to reduce any difference between the measured abundance ratio and the target abundance ratio.

In an embodiment in which the ion detector is initially set to a low gain, as described above, gain adjusting system 250 simply increases the gain of ion detector 230. This has the effect of reducing the difference between the measured abundance ratio and the target abundance ratio.

With its new gain setting, ion detector 230 outputs respective digital signals representing the abundance of each ion species to data acquisition system 240, and the data acquisition system calculates a new measured abundance ratio. Gain adjusting system 250 determines whether the new measured abundance ratio is equal to the target adjustment ratio and, if it is not, adjusts the gain of the ion detector again. Gain adjusting system 250 repeats the process just described until the measured abundance ratio is equal to the target adjustment ratio, i.e., the measured adjustment ratio matches the known adjustment ratio. Ion detector 230 is then returned to its normal operating mode. When in this mode, ion detector 230 or gain adjustment system 250 holds the gain of the ion detector at that at which the measured abundance ratio matched the known abundance ratio when the ion detector was in its calibration mode. This gain setting is held until the next time ion detector 230 is set to its calibration mode.

As noted above, some embodiments of ion detector 230 have a manual gain adjustment. FIG. 9 is a block diagram showing an example of a manual embodiment 260 of gain adjustment system 250 for use with an ion detector that has manual gain adjustment. In this example, gain adjustment system 260 is composed of a first human interface device 262 and a second human interface device 276. First human interface device 262 is connected to receive an electrical signal representing the measured abundance ratio from the output 244 of data acquisition system 240. Second human interface device 276 is connected to provide a gain control signal to the gain control input 236 of ion detector 230.

First human interface device 274 is a human interface device capable of communicating the measured abundance ratio calculated by data acquisition system 240 to the human operator who adjusts the gain of the ion detector. Typically, first human interface device 274 is a display that displays the measured abundance ratio as a digital value or analog quantity. Many types of display having this capability are known in the art, and may be used. Typically, displays are electronic devices, but electromechanical devices, such as meter and gauges, are additionally regarded as displays in the context of this disclosure. While first human interface device 274 typically communicates the measured abundance ratio to the operator visually via the operator's sense of sight, a device that communicates the measured abundance ratio via another of the operator's senses, such as a device that communicates the measured abundance ratio acoustically to the operator's sense of hearing or a device that communicates the measured abundance ratio via a mechanical force conveyed to the operator's sense of touch, can also be used as first human interface device 274.

First human interface device 274 may additionally indicate to the operator the target abundance ratio, discussed above, or the known abundance ratio. Alternatively, the first human interface device may indicate the difference between the measured abundance ratio and target abundance ratio or the known abundance ratio. First human interface device 274 or data acquisition system 240 may include a device by means of which the operator or another may input the known abundance ratio or the target abundance ratio. Alternatively, the known abundance ratio or the target abundance ratio may be stored in first human interface device 274 or data acquisition system 240 in advance.

Second human interface device 276 is a human interface device capable of receiving an input provided by the human operator who adjusts the gain of the ion detector. The input received via the second human interface device changes the gain of the ion detector. Typically, the second human interface device 276 comprises a gain control knob, slider, lever, push-buttons, touch-pad or other mechanical, electromechanical or electrical device that allows an operator to control the gain of the ion detector. Second human interface device 276 generates a gain control signal in response to the received operator input.

To calibrate the ion detector 230 of mass spectrometer 200, a sample comprising two or more species having a known abundance ratio is input to the sample input 212 of ion generator 210. Optionally, the operator uses second human interface device 276 to set ion detector 230 to a gain at which the ion detector detects single ion events less efficiently than multi-ion events. Alternatively, this initial gain setting can be made automatically at the start of the calibration process. Data acquisition system 240 calculates a measured abundance ratio between the ion species and outputs the result to first human interface device 274. The first human interface device communicates the measured abundance ratio to the operator. If the operator determines that the measured abundance ratio is nominally equal to the known abundance ratio, the operator stops the calibration process, and the mass spectrometer 200 is ready for use.

If the operator determines that the measured abundance ratio communicated by first human interface device 274 is different from the known abundance ratio, the operator uses second human interface device 276 to provide an input that changes the gain of ion detector 230. In an embodiment, operator uses second human interface device 276 to increase or decrease the gain of ion detector 230 in the appropriate direction to reduce the difference between the measured abundance ratio and the target abundance ratio. In an embodiment in which the gain of the ion detector is initially set to a low value, the operator uses second human interface device 276 to increase the gain of ion detector 230. This has the effect of reducing the difference between the measured abundance ratio and the target abundance ratio.

The new gain setting of the ion detector changes the measured abundance ratio communicated to the operator by first human interface device 274. The operator determines whether the new measured abundance ratio is nominally equal to the known abundance ratio and, if it is not, makes an additional gain adjustment using second human interface device 276. The operator repeats this process until the measured abundance ratio is nominally equal to the known adjustment ratio. Ion detector 230 is then returned to its normal operating mode. When in this mode, the gain of the ion detector is held at that which produced a measured abundance ratio nominally equal to the known adjustment ratio when the ion detector was in its calibration mode. This gain setting is held until the next time the ion detector is set to its calibration mode.

As noted above, other embodiments of ion detector 230 have an automatic gain adjustment. FIG. 10 is a block diagram showing an example of an automatic embodiment 270 of gain adjustment system 250 that automatically adjusts the gain of ion detector 230. In the example shown, gain adjustment system 270 is composed of a comparator 272, a target abundance ratio (TAR) source 274, an up/down counter 276, a transition rate counter 278 and an AND gate 280.

Comparator 272 has two inputs and an output. One input is connected to the output 244 of data acquisition system 240 to receive successive values of measured abundance ratio MAR.

Target adjustment ratio source 274 is typically a memory that stores a value of target adjustment ratio TAR for the two or more ion species used to calibrate mass spectrometer 200. Target adjustment ratio source 274 has an output connected to the other input of comparator 272. The output of comparator 272 has a state (high or low) that depends on whether measured abundance ratio MAR is greater than or less than target abundance ratio TAR.

Up/down counter 276 has a direction input, a clock input and an output. The output is connected to the gain control input 236 of ion detector 230, and provides a digital gain control signal to the ion detector. For embodiments of ion detector 230 that require an analog gain control signal, a digital-to-analog converter (not shown) is interposed between the output of up/down counter 276 and the gain control input 236 of ion detector 230. The direction control input is connected to the output of comparator 272. The state of the output of comparator 272 at the direction control input determines whether up/down counter 276 counts in a sense that increases or decreases the gain control signal provided to ion detector 230.

Transition rate counter 278 has a signal input, a clock input, a reset input and an output. The signal input is connected to the output of comparator 272. The clock input is connected to receive a clock signal CLO. The reset input is connected to receive a reset signal R. Momentarily applying the reset signal R to the reset input sets the output of transition rate counter 278 to a predetermined one of its states. The output of the transition rate counter changes to the other of its states when the rate at which transitions occur at the signal input exceeds a predetermined rate. The output then remains in its changed state until the reset signal is again momentarily applied to the reset input.

AND gate 280 has two inputs and an output. One input is connected to receive clock signal CLO. The other input is connected to the output of transition rate counter 278. The output is connected to the clock input of up/down counter 276.

To calibrate the ion detector 230 of mass spectrometer 200, reset signal R is momentarily applied to the reset input of transition rate detector 278. This sets the output of the transition rate detector to a state that causes AND gate 280 to pass clock signal CLO to the clock input of up/down counter 276. Optionally, the output of comparator 272 is initially held in a state that causes up/down counter 230 to count the edges of clock signal CLO in a sense that changes the gain control signal to a value that sets the ion detector 230 to a gain at which the ion detector detects single ion events less efficiently than multi-ion events. Once the ion detector has been set to this initial gain, the output of comparator 272 is released.

A sample comprising two or more species having a known abundance ratio is input to the sample input 212 of ion generator 210. Data acquisition system 240 calculates a measured abundance ratio between the ion species and outputs the result to comparator 272 as a value of measured abundance ratio MAR. The output of comparator 272 determines whether up/down counter 276 counts each edge of clock signal CLO received via AND gate 280 in a sense that increments or decrements the gain control signal output to the gain control input 236 of ion detector 230. Each increment or decrement of the gain control signal causes a corresponding small change in the gain of ion detector 230. Up/down counter 276 changes the gain control signal until the gain of the ion detector is such that the difference between the measured abundance ratio and the target abundance ratio changes sign.

The difference between measured abundance ratio MAR received from data acquisition system 240 and target abundance ratio TAR changing sign causes the output of comparator 272 to change state. The change in the output state of comparator 272 causes up/down counter 276 to reverse the direction in which the gain control signal changes. The consequent change in the direction in which the gain of ion detector 230 changes causes the difference between the measured abundance ratio and the target abundance ratio once more to change sign, and the output of comparator 272 once more to change state.

Transition rate counter 278 monitors the output state of comparator 272 and counts the number of times the output changes state during a predetermined number of cycles of clock signal CLO. The output of comparator 272 changing states in more-or-less consecutive clock cycles indicates that measured abundance ratio MAR received from data acquisition system 240 is oscillating about target abundance ratio TAR. When the rate at which the output of comparator 272 changes state exceeds the predetermined rate of transition rate counter 278, the output of the transition rate counter changes state.

The changed output state of transition rate counter 278 causes AND gate 280 to isolate clock signal CLO from the clock input of up/down counter 276. With no clock signal at its clock input, the up/down counter holds the gain control signal at a value corresponding to the measured abundance ratio matching the known abundance ratio. The gain control signal remains at this value until the next time that the gain of the ion detector is calibrated.

The embodiment of gain adjustment system 270 described above with reference to FIG. 10 is merely an example. Servo techniques that employ circuitry or computation and that generate a control signal to vary a parameter, such as gain, to minimize the difference between a measurement, such as a measured abundance ratio, and a target result, such as a target abundance ratio, where the measurement depends on the parameter being varied, are known in the art, and may be used as gain adjustment system 270.

The embodiments of gain control system 270 described above with reference to FIG. 10 can be implemented in hardware, such as an integrated circuit having bipolar, N-MOS, P-MOS or CMOS devices. Design libraries comprising designs for such circuit elements as comparators, volatile and non-volatile memory, up-down counters, digital-to-analog converters, transition rate counters and gates are commercially available can be used to design such hardware implementation of gain control system 270. Alternatively, gain control system 270 can be fabricated from separate circuit elements interconnected by a printed circuit or by some other interconnection technique.

The above-described embodiments of gain control system 270 may alternatively be implemented in pre-fabricated hardware such as an application-specific integrated circuit (ASIC) or a field-programmable gate array (FPGA). Design libraries providing designs for such circuit elements as comparators, volatile and non-volatile memory, up-down counters, digital-to-analog converters, transition rate counters and gates are commercially available can be used to configure such pre-fabricated hardware to provide gain control system 270.

The above-described embodiment of gain control system 270 can alternatively be implemented in software running on a suitable computational device (not shown) such as a microprocessor or a digital signal processor (DSP). The microprocessor or DSP may be an existing microprocessor or DSP that constitutes part of mass spectrometer 200 and that has spare capacity. Programming modules capable of programming a computational device to provide such elements as comparators, volatile and non-volatile memory, up-down counters, digital-to-analog converters, transition rate counters and gates are commercially available and may be used to program a computational device to provide a software implementation of gain control system 270. In such software implementations of gain control system 270, the various elements described in this disclosure are typically ephemeral, and typically only exist temporarily as the program executes.

The program in response to which the computational device operates can be fixed in a suitable computer-readable medium (not shown) such as a set of floppy disks, an optically-readable disk, a hard disk, a CD-ROM, a DVD-ROM, a flash memory, a read-only memory or a programmable read-only memory. The program is then transferred to a memory that forms part of the computational device, or is external to the computational device. Alternatively, the program can be transmitted to the memory of the computational device by a suitable data link. The program may be supplied as part of an upgrade accessory used to add the capability of easier, more accurate calibration of the existing ion detector of an existing mass spectrometer.

This disclosure describes the invention in detail using illustrative embodiments. However, the invention defined by the appended claims is not limited to the precise embodiments described.

We claim:

1. A method of calibrating the gain of the ion detector of a mass spectrometer, the method comprising:
setting the ion detector to a gain less than that at which the ion detector effectively detects single ions;
using the ion detector, measuring a ratio of abundances of at least two ion species having a known abundance ratio; and
increasing the gain of the ion detector until the measured abundance ratio matches the known abundance ratio.

2. The method of claim 1, in which the ion species having the known abundance ratio are ions of constituent species of air.

3. The method of claim 1, in which the ion species having the known abundance ratio are ions of constituents species of an organic solvent.

4. The method of claim 1, in which the increasing is performed automatically.

5. The method of claim 4, additionally comprising:
determining when the measured ratio matches the known ratio; and
halting the incrementing when the measured abundance ratio matches the known abundance ratio.

6. The method of claim 1, in which:
the detector gain is manually adjustable; and
the incrementing comprises:
communicating the measured abundance ratio to an operator; and
manually incrementing the gain of the ion detector in response to the communicated measured abundance ratio.

7. The method of claim 6, in which:
the incrementing additionally comprises displaying a target abundance ratio that is greater than the known abundance ratio by a predetermined difference; and
the manually incrementing is performed additionally in response to the displayed target abundance ratio.

8. The method of claim 1, in which:
the detector gain is manually adjustable; and
the incrementing comprises:
communicating to an operator a difference between the measured abundance ratio and a target abundance ratio, the target abundance ratio greater than the known abundance ratio by a predetermined difference; and
manually incrementing the gain of the ion detector in response to the communicated difference of the abundance ratios.

9. A mass spectrometer, comprising:
an ion source, a mass analyzer and an ion detector arranged to allow ions to pass from the ion source to the ion detector via the mass analyzer, the ion detector having a controllable gain;
a data acquisition system operable in response to the ion detector to determine a measured ion abundance ratio for at least two ion species having a known abundance ratio; and
a gain adjustment system operable to change the gain of the ion detector to make the measured abundance ratio determined by the data acquisition system match the known abundance ratio.

10. The mass spectrometer of claim 9, in which:
the gain of the ion detector is controllable by a gain control signal; and
the gain adjustment system comprises a comparator operable to generate the control signal by comparing the measured abundance ratio with a target abundance ratio, the target abundance ration greater than the known abundance ratio by a predetermined difference.

11. The mass spectrometer of claim 9, in which the gain adjustment system is additionally operable to generate the gain control signal in a state that sets the ion detector to a gain at which the ion detector detects single-ion events significantly less efficiently than multi-ion events.

12. The mass spectrometer of claim 9, in which:
the gain of the ion detector is controllable manually; and
the gain adjustment system comprises:
a first human interface device coupled to the data acquisition system, the first human interface device operable to communicate the measured abundance ratio to a human operator, and
a second human interface device operable to receive a gain adjustment input from the human operator.

13. A method of calibrating the gain of the ion detector of a mass spectrometer, the method comprising:
using the ion detector, measuring a ratio of abundances of at least two ion species having a known abundance ratio; and
changing the gain of the ion detector until the measured abundance ratio matches the known abundance ratio.

14. The method of claim 13, in which the changing is performed automatically.

15. The method of claim 14, additionally comprising:
determining when the measured abundance ratio matches the known abundance ratio; and
halting the changing when the measured abundance ratio matches the known abundance ratio.

16. The method of claim 13, in which:
the detector gain is manually adjustable; and
the changing comprises:
communicating the measured abundance ratio to an operator; and
manually changing the gain of the ion detector in response to the communicated measured abundance ratio.

17. The method of claim 16, in which:
the changing additionally comprises displaying a target abundance ratio that is greater than the known abundance ratio by a predetermined difference; and
the manually changing is performed additionally in response to the displayed target abundance ratio.

18. The method of claim 13, in which:
the detector gain is manually adjustable; and
the changing comprises:
communicating to an operator a difference between the measured abundance ratio and a target abundance ratio, the target abundance ratio greater than the known abundance ratio by a predetermined difference; and
manually changing the gain of the ion detector in response to the communicated difference of the abundance ratios.

19. A computer-readable medium in which is fixed a program operable to cause a computational device to perform a method that calibrates the gain of the ion detector of a mass spectrometer, the method comprising:
using the ion detector, measuring a ratio of abundances of at least two ion species having a known abundance ratio to provide a measured abundance ratio; and
changing the gain of the ion detector until the measured abundance ratio matches the known abundance ratio.

20. The computer-readable medium of claim 19, in which the method performed by the computational device in response to the program fixed therein additionally comprises:
determining when the measured abundance ratio matches the known abundance ratio; and
halting the changing when the measured abundance ratio matches the known abundance ratio.
